(19) United States
(12) Patent Application Publication
(10) Pub. No.: US 2023/0326422 A1
(43) Pub. Date: Oct. 12, 2023

(54) METHOD OF IMPROVING THE BRIGHTNESS OF LIQUID CRYSTAL PROJECTORS

(71) Applicant: Li Chen, Shenzhen (CN)

(72) Inventor: Li Chen, Shenzhen (CN)

(21) Appl. No.: 17/896,095

(22) Filed: Aug. 26, 2022

(30) Foreign Application Priority Data
Apr. 11, 2022 (CN) 202210376942.4

(51) Int. Cl. G09G 3/36

(52) U.S. Cl. CPC G09G 3/3607; G09G 2320/0233

(57) ABSTRACT

The invention discloses a method of improving the brightness of liquid crystal projectors, comprising the following steps: step 1: one pixel is composed of three sub-pixels; increasing the area ratio of green sub-pixels in the pixel and reducing the area ratio of red and blue sub-pixels; step 2: the illumination light source does not follow the RGB ratio of white light; under the condition that the total luminous energy remains unchanged, reducing the ratio of green light in the light source, and increasing the ratio of red light and blue light in the light source; step 3: multiplying the RGB ratio by the corresponding sub-pixel area, and the obtained result conforms to the RGB ratio in white balance. By changing the luminosity of pixels and RGB, more light can be transmitted under the same light energy density, which is an important method to improve the brightness of liquid crystal projectors.

### 1. TECHNICAL FIELD

The invention related to the field of projectors, and in particular to a method of improving the brightness of liquid crystal projectors.

### 2. BACKGROUND ART

Brightness is an important parameter of the projector. Due to the low transmittance of the LCD screen, most of the light is converted into heat energy, and the temperature resistance of the LCD screen is poor, which limits the energy density of the light of the LCD screen. Therefore, in the case of the same optical energy density, more light can be transmitted, which has become an important method to improve the brightness of liquid crystal projectors.

One pixel of a conventional LCD screen is composed of three sub-pixels, the color temperature is 7000K white light, and its RGB three-color light composition is 5.8% of B, 73.3% of G, and 20.9% of R, as shown in FIG. 1. One pixel of a conventional LCD screen is composed of three sub-pixels, as shown in FIG. 2, and the area of each sub-pixel is the same. Each sub-pixel can only transmit light of the corresponding color. Without considering other factors, the transmitted light of each pixel is equal to the sum of the transmitted light of three sub-pixels, which satisfies the following formula:

Pixel transmittance=sub-pixel B area (⅓)*light B ratio (5.8%)+sub-pixel G area (⅓)*light G ratio (73.3%)+sub-pixel R area (⅓)*light R ratio (20.9%)=33.33%.

### 3. SUMMARY OF THE INVENTION

The technical problem to be solved by the invention is to provide a method of improving the brightness of liquid crystal projectors. By changing the luminosity of pixels and RGB, more light can be transmitted under the same light energy density, which is an important method to improve the brightness of liquid crystal projectors.

The invention is realized by the following technical solutions: a method of improving the brightness of liquid crystal projectors, comprising the following steps:
step 1: one pixel is composed of three sub-pixels; increasing the area ratio of green sub-pixels in the pixel and reducing the area ratio of red and blue sub-pixels;
step 2: the illumination light source does not follow the RGB ratio of white light; under the condition that the total luminous energy remains unchanged, reducing the ratio of green light in the light source, and increasing the ratio of red light and blue light in the light source;
step 3: multiplying the RGB ratio by the corresponding sub-pixel area, and the obtained result conforms to the RGB ratio in white balance.

Preferably, under the condition that the color temperature is allowed to be changed, reducing the ratio of red light to increase the brightness.

Preferably, under the condition that the image quality is allowed to be lowered, merging the R and B sub-pixels, and the arrangement order of the sub-pixels is GR GB GR GB.

Preferably, under the condition that the R and B sub-pixels are merged, G sub-pixels are displayed normally, and RB sub-pixels are displayed in chronological order; for example, the odd-numbered pixels of the first frame display three sub-pixels of RGB, and the even-numbered pixels only display one sub-pixel of G, that is, RGB G RGB G RGB G; the odd-numbered pixels in the second frame only display one sub-pixel of G, and the even-numbered pixels display three sub-pixels of BGR, that is, G BGR G RGB G BGR, and so on.

It can also be combined into the following arrangement:
First row: RGBGRGBGRGBG
Second row: BG RG BG RG BG RG.

The display method for odd-numbered frames is:
First row: RGBGRGBGRGBG.
Second row: Bg Rg Bg Rg Bg Rg.

(Capital letters are the display content of odd-numbered rows of pixels, and lowercase letters are the display content of even-numbered rows of pixels.)

The display method for even-numbered frames is:
First row: rG bG rG bG rG bG.
Second row: bg rg bg rg bg rg.

(Capital letters are the display content of odd-numbered rows of pixels, and lowercase letters are the display content of even-numbered rows of pixels.)

The advantageous effects of the invention are: by changing the luminosity of pixels and RGB, more light can be transmitted under the same light energy density, which is an important method to improve the brightness of liquid crystal projectors.

### 4. BRIEF DESCRIPTION OF ACCOMPANY DRAWINGS

In order to more clearly illustrate the embodiments of the invention or the technical solutions in the prior art, the accompanying drawings that need to be used in the description of the embodiments or the prior art will be briefly introduced hereinafter. Obviously, the drawings in the following description are only some embodiments of the invention. For those of ordinary skill in the art, other drawings can also be obtained from these drawings without creative effort.

FIG. 1 is a light ratio diagram of conventional RGB three-color light in the prior art;

FIG. 2 is a sub-pixel ratio diagram in the prior art;

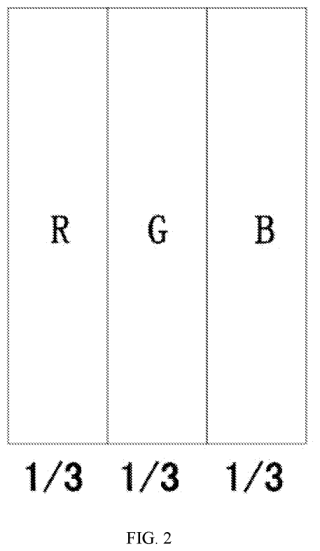

FIG. 3 is a sub-pixel ratio diagram after improvement according to the invention;

FIG. 4 is a light ratio diagram of conventional RGB three-color light after improvement according to the invention.

### 5. SPECIFIC EMBODIMENT OF THE INVENTION

All features disclosed in this specification, or steps in all methods or processes disclosed, may be combined in any way except mutually exclusive features and/or steps.

Any feature disclosed in this specification (including any accompanying claims, abstract and drawings), unless expressly stated otherwise, may be replaced by other equivalent or alternative features serving a similar purpose. That is, unless expressly stated otherwise, each feature is but one example of a series of equivalent or similar features.

### Embodiment 1

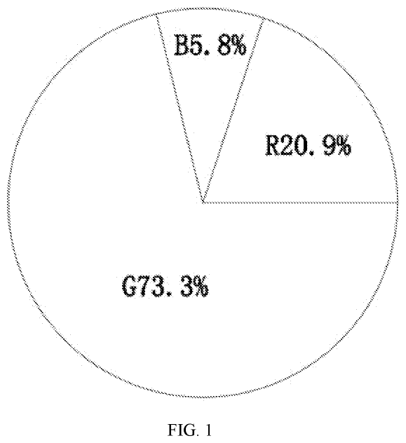

As shown in FIG. 1, a method of improving the brightness of liquid crystal projectors, increasing the area ratio of the green sub-pixel in the pixel, reducing the area ratio of the red and blue sub-pixels; at the same time reducing the ratio of green light in the light source, and increasing the ratio of red light and blue light in the light source.

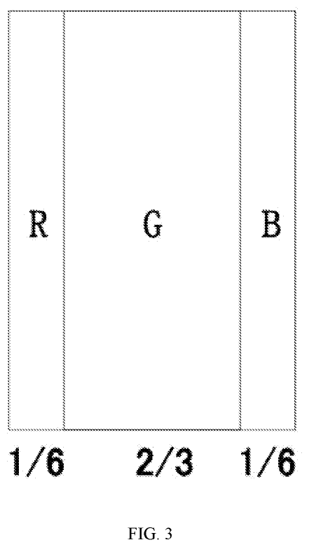

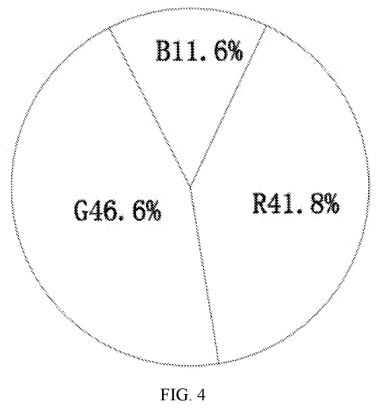

For example, increasing the area ratio of the green sub-pixel in the pixel to ⅔ of the pixel area, and reducing the area ratio of the red and blue sub-pixels to ⅙ of the pixel area, as shown in FIG. 3; at the same time adjusting the composition of the light source: doubling the ratio of red and blue; for example, the ratio of red is 41.8%, the ratio of green is 46.6%, and the ratio of blue is 11.6%, as shown in FIG. 4.

Then the transmittance of the total new pixels=⅙*11.6%+⅔*46.6%+⅙*41.8%=39.96%, the ratio of each color light passing through the LCD screen is still: 5.8:73.3:20.9, and the color temperature remains the same.

Transmittance: new pixel/regular pixel=39.96%/33.33%=120%, so the transmittance is increased by 20%.

### Embodiment 2

Further, since human vision is less sensitive to red, the lack of red has less impact on image quality, only affecting the color rendering index, therefore, in areas that do not require high color reproduction, the brightness can be further improved by sacrificing the red image quality. Since the eyes are sensitive to green and not to red, under the same brightness, the color temperature of the picture will only increase, and the visual perception will be brighter.

For example: the ratio of red is reduced from 41.8% to 20.9%, the composition of RGB is: 15.89% of B, 63.92% of G, and 20.9% of R; transmittance of total new pixels=⅙*15.89%+⅔*63.92%+⅙*20.9%=48.75%;

Transmittance: new pixel/regular pixel=48.75%/33.33%=162.5%, so the transmittance is increased by 62.5%.

### Embodiment 3

Further, human vision is most sensitive to green light, and is much less sensitive to red and blue light, therefore, the actual resolution is determined by the number of green sub-pixels, and the effect of red and blue light is mainly reflected in color. Therefore, as long as the number of green sub-pixel points is guaranteed, the resolution is basically guaranteed. The sub-pixel arrangement order of a conventional LCD screen is sequential arrangement of RGB RGB RGB RGB. The sub-pixel arrangement order of the liquid crystal screen of the invention is: RGB BGR RGB BGR; since the R or B sub-pixels are the same as the adjacent pixels, they can be merged if the image quality requirements are not particularly high; after merging, the number of sub-pixels is reduced by ⅓.

Since the wires and TFT structures in the LCD screen account for about 45% of the area of the LCD screen, and the wires and TFT structures are opaque, so if ⅓ sub-pixels are reduced, the opaque area can be reduced by ⅓*45%=15%, the corresponding light-transmitting area will be increased from 55% to 70%, and the transmittance is increased by: 70%/55%=127.27%.

By superimposing Embodiment 1, the transmittance is increased to 120%*127.27%=152.72%, and the transmittance is increased by 52.72%;

By superimposing Embodiment 2, the transmittance is increased to 162.5%*127.27%=206.81%, and the transmittance is increased by 106.81%. The display method of two adjacent pixels on a conventional LCD screen is that: the first frame is RGB RGB RGB, and the second frame is RGB RGB RGB; the display method of two adjacent pixels after merging RB sub-pixels is: the first frame is RGB G RGB G, and the second frame is G BGR G BRG, that is, the odd-numbered pixels of the first frame display three sub-pixels of RGB, and the even-numbered pixels only display one sub-pixel of G; the odd-numbered pixels in the second frame only display one sub-pixel of G, and the even-numbered pixels display three sub-pixels of BGR, and so on.

It can also be combined into the following arrangement:
First row: RGBGRGBGRGBG.
Second row: BG RG BG RG BG RG

The display method for odd-numbered frames is:
First row: RGBGRGBGRGBG.
Second row: Bg Rg Bg Rg Bg Rg.

Capital letters are the display content of odd-numbered rows of pixels, and lowercase letters are the display content of even-numbered rows of pixels.

The display method for even-numbered frames is:
First row: rG bG rG bG rG bG.
Second row: bg rg bg rg bg rg.

Capital letters are the display content of odd-numbered rows of pixels, and lowercase letters are the display content of even-numbered rows of pixels.

The above are only specific embodiments of the invention, but the protection scope of the invention is not limited thereto. Any modifications or substitutions that are not thought of through creative work should be included within the protection scope of the invention. Therefore, the protection scope of the invention should be based on the protection scope defined by the claims.

What is claimed is:

1. A method of improving brightness of liquid crystal projectors, comprising the following steps:
step 1: one pixel is composed of three sub-pixels; increasing an area ratio of green sub-pixels in the pixel and reducing an area ratio of red and blue sub-pixels;
step 2: an illumination light source does not follow the RGB ratio of white light;
under the condition that the total luminous energy remains unchanged, reducing a ratio of green light in the light source, and increasing a ratio of red light and blue light in the light source;
step 3: multiplying the RGB ratio by the corresponding sub-pixel area, and the obtained result conforms to the RGB ratio in white balance;
step 4: under the condition that a color temperature is allowed to be changed, reducing the ratio of R to further improve the brightness of a projector;
step 5: under the condition that an image quality is allowed to be lowered, merging the R and B sub-pixels of adjacent pixels to reduce a pixel density, so as to further improve a light transmittance of the liquid crystal screen.

2. The method of improving the brightness of liquid crystal projectors of claim 1, wherein under the condition that the color temperature is allowed to be changed, reducing the ratio of red light to increase the brightness.

3. The method of improving the brightness of liquid crystal projectors of claim 1, wherein under the condition that the image quality is allowed to be lowered, merging the R and B sub-pixels.

4. (canceled)
